(19) United States
(12) Patent Application Publication
(10) Pub. No.: US 2021/0080949 A1
(43) Pub. Date: Mar. 18, 2021

(54) DRIVING AUTHORITY TRANSFER DEVICE

(71) Applicant: TOYODA GOSEI CO., LTD., Kiyosu-shi, Aichi-ken (JP)

(72) Inventors: Shinichi TAKEDA, Kiyosu-shi, Aichi-ken (JP); Bunpei MORITA, Kiyosu-shi, Aichi-ken (JP); Yoshiki NAKAMURA, Kiyosu-shi, Aichi-ken (JP); Kunihiro NOKURA, Kiyosu-shi, Aichi-ken (JP); Kazuhisa TAKAHASHI, Kiyosu-shi, Aichi-ken (JP); Naoto KURIYAMA, Kiyosu-shi, Aichi-ken (JP); Takafumi NAKANISHI, Kiyosu-shi, Aichi-ken (JP)

(21) Appl. No.: 16/966,597

(22) PCT Filed: Mar. 19, 2019
(86) PCT No.: PCT/JP2019/011450

§ 371 Date: Jul. 31, 2020

(30) Foreign Application Priority Data
Mar. 27, 2018 (JP) 2018-060396

(51) Int. Cl. G05D 1/00; B60W 60/00; B60W 50/14

(52) U.S. Cl. CPC G05D 1/0061; B60W 2540/223; B60W 50/14; B60W 60/0053

(57) ABSTRACT

An authority transfer device is used for a vehicle having an autonomous driving mode in which driving operation is autonomously performed for a driver and a manual driving mode in which driving operation is manually performed by the driver using at least a steering wheel. The authority transfer device includes a controller configured, when switching from the autonomous driving mode to the manual driving mode, to transfer a driving authority of the vehicle to the driver on condition that at least a grip of the driver on the steering wheel is detected. The controller notifies the driver that the driving authority will be transferred before the driving authority is transferred.

### CROSS REFERENCE TO RELATED APPLICATIONS

This application is a U.S. national stage application of International Patent Application No. PCT/JP2019/011450 filed on Mar. 19, 2019, which claims priority to Japanese Patent Application No. 2018-060396 filed on Mar. 27, 2018, the contents of which are incorporated herein by reference.

### BACKGROUND

The present disclosure relates to an authority transfer device that transfers the authority to drive a vehicle having an autonomous driving function to the driver when switching from an autonomous driving mode to a manual driving mode.

A vehicle having an autonomous driving function corresponding to the automated driving level 3 has an autonomous driving mode in which driving operation is autonomously performed for the driver and a manual driving mode in which driving operation is manually performed by the driver using at least the steering wheel. In the autonomous driving mode, the driver is released from the driving operation and may remove his or her hands from the steering wheel.

When the autonomous driving mode becomes difficult to continue, the driving mode is switched to the manual driving mode. During this switching, the driver needs to have a posture appropriate for driving operation in the manual driving mode. In this regard, the vehicle is provided with an authority transfer device that transfers the authority to drive the vehicle to the driver on condition that the steering wheel is gripped by the driver when switching from the autonomous driving mode to the manual driving mode. Patent Document 1 describes an example of determination of whether the steering wheel is gripped made based on a detection result of a sensor (contact detector) detecting whether a hand of the driver is in contact with the steering wheel.

### PRIOR ART DOCUMENT

### Patent Document

Patent Document 1: Japanese Laid-Open Patent Publication No. 2016-38846

In the typical authority transfer device described above, information on the authority transfer provided to the driver is only that “detection of a grip on the steering wheel” is set as an execution condition of the authority transfer. The driver is provided with very little information on whether and when the driving authority is transferred. Therefore, before the driver is prepared for an appropriate response to the driving operation in the manual driving mode, the driving authority may be transferred to the driver.

It is an objective of the present disclosure to provide an authority transfer device that transfers the driving authority to the driver at a more appropriate time when switching from the autonomous driving mode to the manual driving mode.

In an aspect, an authority transfer device is used for a vehicle having an autonomous driving mode in which driving operation is autonomously performed for a driver and a manual driving mode in which driving operation is manually performed by the driver using at least a steering wheel. The authority transfer device is configured, when switching from the autonomous driving mode to the manual driving mode, to transfer a driving authority of the vehicle to the driver on condition that at least a grip of the driver on the steering wheel is detected. The authority transfer device includes a notifier to notify the driver that the driving authority will be transferred before the driving authority is transferred.

With the configuration described above, the driver recognizes that the driving authority will be transferred in advance through the notifier. Thus, the driver receives more information than when the authority transfer execution condition is only detection of a grip on the steering wheel. As a result, the driver receives the transfer of the driving authority when the driver is sufficiently prepared for an appropriate response to driving operation in the manual driving mode.

In another aspect, an authority transfer device is used for a vehicle having an autonomous driving mode in which driving operation is autonomously performed for a driver and a manual driving mode in which driving operation is manually performed by the driver using at least a steering wheel. The authority transfer device is configured, when switching from the autonomous driving mode to the manual driving mode, to transfer a driving authority of the vehicle to the driver on condition that at least a grip of the driver on the steering wheel is detected. The authority transfer device includes a notifier to notify the driver that a grip on the steering wheel is detected before the driving authority is transferred.

With the configuration described above, the driver recognizes that a grip on the steering wheel is detected and that the driving authority will be transferred in advance through the notifier. Thus, the driver receives more information than when the condition for transferring the authority is only detection of a grip on the steering wheel. As a result, the driver receives the transfer of the driving authority when the driver is sufficiently prepared for an appropriate response to driving operation in the manual driving mode.

In another aspect, an authority transfer device is used for a vehicle having an autonomous driving mode in which driving operation is autonomously performed for a driver and a manual driving mode in which driving operation is manually performed by the driver using at least a steering wheel. The authority transfer device is configured, when switching from the autonomous driving mode to the manual driving mode, to transfer a driving authority of the vehicle to the driver on condition that at least a grip of the driver on the steering wheel is detected. The authority transfer device includes a notifier to notify the driver of a remaining time before the driving authority is transferred.

With the configuration described above, the driver recognizes that the driving authority will be transferred after the notified remaining time has elapsed. That is, the driver recognizes when the driving authority is transferred. Thus, the driver receives more information than when the condition for transferring the authority is only detection of a grip on the steering wheel. As a result, the driver receives the transfer of the driving authority when the driver is sufficiently prepared for an appropriate response to driving operation in the manual driving mode.

The authority transfer device described above may be configured to transfer the driving authority of the vehicle to the driver on condition that a preset transfer execution action is performed by the driver in addition to detection of a grip on the steering wheel by the driver. The transfer execution action may include a continuous grip on the steering wheel for a predetermined time.

When the driver continuously grips the steering wheel for the predetermined time, preparation for an appropriate response to driving operation in the manual driving mode is enhanced as compared to when the driver merely grips the steering wheel. When the condition for transferring the authority includes a continuous grip on the steering wheel for the predetermined time in addition to a grip on the steering wheel by the driver, the authority transfer further reflects the intention of the driver.

The transfer execution action may include a grip on an indicated portion of the steering wheel.

When the driver grips the indicated portion of the steering wheel, preparation for an appropriate response to driving operation in the manual driving mode is enhanced as compared to when the driver merely grips an arbitrary portion of the steering wheel. When the condition for transferring the authority includes a grip on the indicated portion of the steering wheel in addition to a grip on the steering wheel by the driver, the authority transfer further reflects the intention of the driver.

The transfer execution action may include an action that is different from a grip on the steering wheel and is taken when performing driving operation in the manual driving mode.

When the driver grips the steering wheel and performs another action that is different from gripping the steering wheel and is taken when performing driving operation in the manual driving mode, preparation for an appropriate response to driving operation in the manual driving mode is enhanced as compared to when the driver merely grips the steering wheel. When the condition for transferring the authority includes another action that is different from gripping the steering wheel and is taken when performing driving operation in the manual driving mode in addition to a grip on the steering wheel by the driver, the authority transfer further reflects the intention of the driver.

The authority transfer device described above transfers the driving authority to the driver at a more appropriate time when switching from the autonomous driving mode to the manual driving mode.

### BRIEF DESCRIPTION OF THE DRAWINGS

FIG. 1 is a schematic diagram showing an embodiment of an authority transfer device.

FIG. 2 is a front view of a steering wheel.

FIG. 3 is a front view of a steering wheel.

FIG. 4 is a flowchart showing a driving authority transfer process executed by a controller in an embodiment.

FIG. 5 is a flowchart showing the driving authority transfer process following FIG. 4.

FIG. 6 is a flowchart showing the driving authority transfer process following FIG. 5.

### DETAILED DESCRIPTION OF THE PREFERRED EMBODIMENTS

An embodiment of an authority transfer device will be described below with reference to the drawings.

In the description hereafter, the front and the rear respectively refer to a direction in which the vehicle travels forward and a direction in which the vehicle travels rearward. The upper-lower direction refers to the upper-lower direction of the vehicle. The left and the right conform to the left and the right in the widthwise direction of the vehicle when traveling forward.

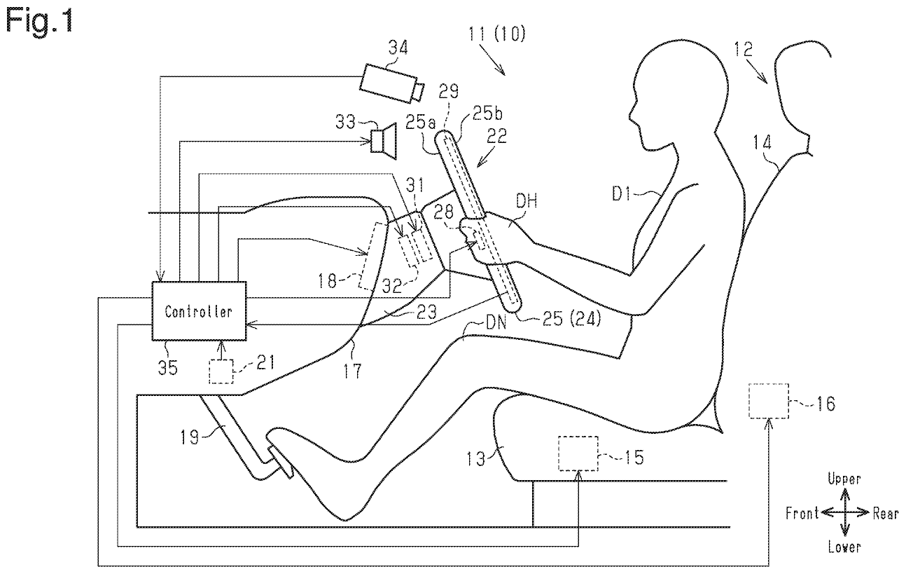

As shown in FIG. 1, a driver seat 12 is located in a passenger compartment 11 of a vehicle 10. The driver seat 12 includes a seat cushion 13 supporting the lower body of a driver D1 from a lower side and a seat back 14 located on a rear end of the seat cushion 13 to support the upper body of the driver D1 from a rear side.

The driver seat 12 is provided with a seat cushion driver 15 and a seat back driver 16. The seat cushion driver 15 is used to adjust a front-rear position of the seat cushion 13 between a position suitable for the driver D1 to grip a steering wheel 24 and perform driving operation and a position suitable for relaxing with his or her hands removed from the steering wheel 24. The seat back driver 16 is used to adjust an inclination angle of the seat back 14 between an upright position suitable for the driver D1 to grip the steering wheel 24 and perform driving operation and an inclined position suitable for relaxing with his or her hands removed from the steering wheel 24.

An instrument panel 17 incorporating meters and switches is located in a front portion of the passenger compartment 11. The instrument panel 17 incorporates a display 18 showing various types of information.

Operating pedals such as an accelerator pedal and a brake pedal are provided at a lower side of the instrument panel 17. FIG. 1 shows an accelerator pedal 19. An accelerator sensor 21 is provided in the vicinity of the accelerator pedal 19 to detect a depression amount of the accelerator pedal 19 (accelerator operation amount) operated by the driver D1.

A steering device 22 is provided at the front of the driver seat 12 in the passenger compartment 11 to change the traveling direction of the vehicle 10. The steering device 22 includes a steering column 23 and the steering wheel 24 rotationally provided at a rear side of the steering column 23. A steering shaft (not shown) is located in the steering column 23 to transmit rotation of the steering wheel 24 to a steering gearbox (not shown). The steering wheel 24 is coupled to a rear end of the steering shaft to rotate integrally with the steering shaft.

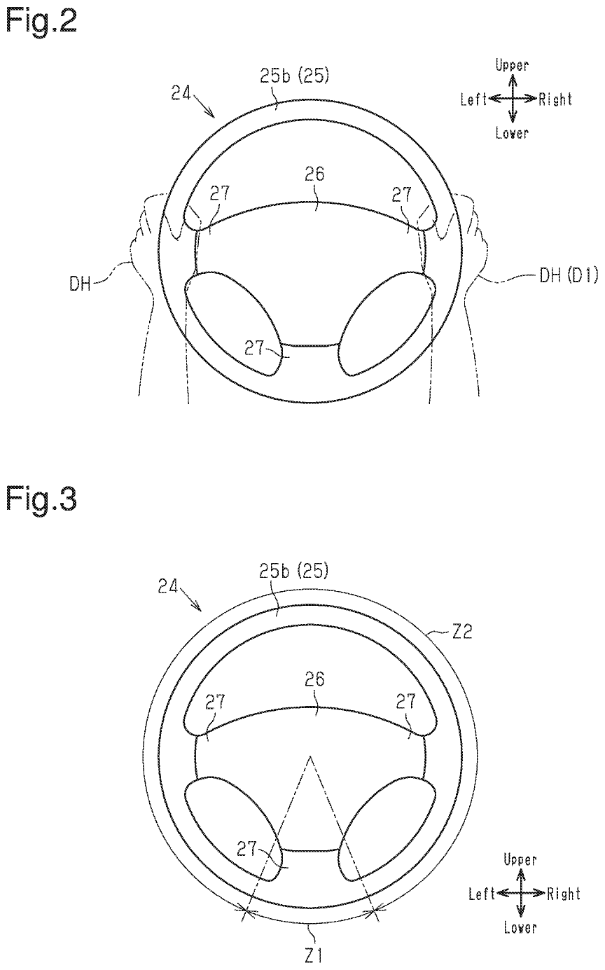

As shown in FIGS. 1 and 2, the steering wheel 24 includes a rim 25 (may be referred to as the handle or the ring), a pad 26, and spokes 27. The rim 25 is generally annular and is gripped and rotated (steered) by the driver D1. The pad 26 is located in a space surrounded by the rim 25. The spokes 27 are arranged at multiple locations between the rim 25 and the pad 26.

Vibration generators 28 are incorporated in the steering wheel 24 on multiple portions gripped by the driver D1 when steering straight forward, for example, portions of the rim 25 connected to the left and right spokes 27. For example, a motor including an oscillator attached to the output shaft to generate vibration, or an oscillating motor, may be used as the vibration generators 28. However, the vibration generators 28 are not limited to an oscillating motor and may be any device capable of generating vibration.

The rim 25 incorporates a grip sensor 29 detecting whether the driver D1 is gripping the rim 25. Examples of the grip sensor 29 include a capacitance sensor, a pressure sensor, a torque sensor, a vibration sensor, and a photoelectric sensor.

When the grip sensor 29 is configured by a capacitance sensor, whether the rim 25 is gripped is detected based on a change in capacitance when the driver D1 grips the rim 25. When the grip sensor 29 is configured by a pressure sensor, whether the rim 25 is gripped is detected based on detection of pressure applied to the rim 25 when gripped. When the grip sensor 29 is configured by a torque sensor, whether the rim 25 is gripped is detected based on detection of torque applied to the rim 25 when gripped and rotated.

When the grip sensor 29 is configured by a vibration sensor, whether the rim 25 is gripped is detected based on detection of vibration of the steering wheel 24. More specifically, the steering wheel 24 receives vibration of the engine and vibration of the vehicle body when the vehicle 10 is traveling on a road having large irregularities. The vibration mode of the steering wheel 24 differs between when the rim 25 is not gripped and when the rim 25 is gripped. The grip sensor 29 configured by a vibration sensor detects a grip on the rim 25 by detecting a vibration mode that differs from the vibration mode in a non-gripped state.

When the grip sensor 29 is configured by a photoelectric sensor, the sensor includes a light transmitter and a light receiver. When light transmitted from the light transmitter is blocked or reflected by a hand DH of the driver D1 gripping the rim 25, the amount of light reaching the light receiver changes. Whether the rim 25 is gripped is detected based on the changes in the amount of light.

A capacitance sensor, a pressure sensor, a torque sensor, a vibration sensor, and a photoelectric sensor may be used individually as the grip sensor 29. Alternatively, two or more of the sensors may be used in combination. When two or more grip sensors 29 are used, even if one of the grip sensors 29 performs an unstable detection, the remaining grip sensors 29 properly detect whether the rim 25 is gripped.

In addition, a camera may be installed in the passenger compartment 11, for example, on the ceiling, and an image captured by the camera may be processed to detect an action of the driver D1 trying to grip the steering wheel 24.

The vehicle 10 incorporates an actuator 31 to move the steering wheel 24 in the front-rear direction and an actuator 32 to change the inclination angle of the steering wheel 24.

A speaker 33 is provided in the passenger compartment 11 to notify various types of information to the driver D1 with sound (including voice).

A camera 34 is incorporated in the passenger compartment 11 at the front of the driver D1, for example, in the instrument panel 17, in a rearview mirror, or in the steering wheel 24 to capture an image of the face of the driver D1.

The vehicle 10 includes an autonomous driving controller (hereafter, simply referred to as “controller 35”) that autonomously performs driving operation such as acceleration, deceleration, braking, and steering of the vehicle 10 for the driver D1 to cause the vehicle 10 to travel. In this description, autonomous driving includes not only causing the vehicle 10 to completely autonomously travel to a designated destination, but also, for example, performing only part of driving operation related to traveling of the vehicle 10 such as lane departure prevention assistance or inter-vehicle distance and lane control.

The controller 35 causes the vehicle 10 to travel along the route to the destination while comparing the current location with road map data. In addition, the controller 35 recognizes surrounding environment such as traffic of surrounding vehicles, signals, signs, road configurations and blockages to determine operation such as acceleration, deceleration, braking, and steering necessary for an appropriate traveling. The controller 35 actuates various types of actuators to cause the vehicle 10 to travel in accordance with the determined operation.

The controller 35 has an autonomous driving function corresponding to automated driving level 3. To fulfill the autonomous driving function corresponding to automated driving level 3, an autonomous driving mode in which driving operation is autonomously performed for the driver D1 and a manual driving mode in which driving operation is manually performed by the driver D1 using at least the steering wheel 24 are set in the vehicle 10. When driving operation is performed in the autonomous driving mode, the driver D1 is released from the driving operation and is allowed to remove his or her hands from the steering wheel 24. The driver D1 may operate a mobile device or look at the face of a passenger when having a conversation with the passenger.

When the autonomous driving mode becomes difficult to continue, the controller 35 requests that the driver D1 should perform driving operation in the manual driving mode. However, to respond to the request, the driver D1 needs to have a posture appropriate for driving operation in the manual driving mode. In this regard, when switching from the autonomous driving mode to the manual driving mode, the controller 35 transfers the authority to drive the vehicle 10 to the driver D1 on condition that a grip on the steering wheel 24 by the driver D1 is detected and an optional condition that the driver D1 performs a transfer execution action, which is described later.

The seat cushion driver 15, the seat back driver 16, the display 18, the accelerator sensor 21, the vibration generators 28, the grip sensor 29, the actuators 31 and 32, the speaker 33, and the camera 34 are connected to the controller 35. The controller 35 executes the process for transferring the authority to drive the vehicle 10 through actuation of, for example, the seat cushion driver 15, the seat back driver 16, the display 18, the vibration generators 28, the actuators 31 and 32, and the speaker 33 based on information received from, for example, the grip sensor 29, the accelerator sensor 21, and the camera 34.

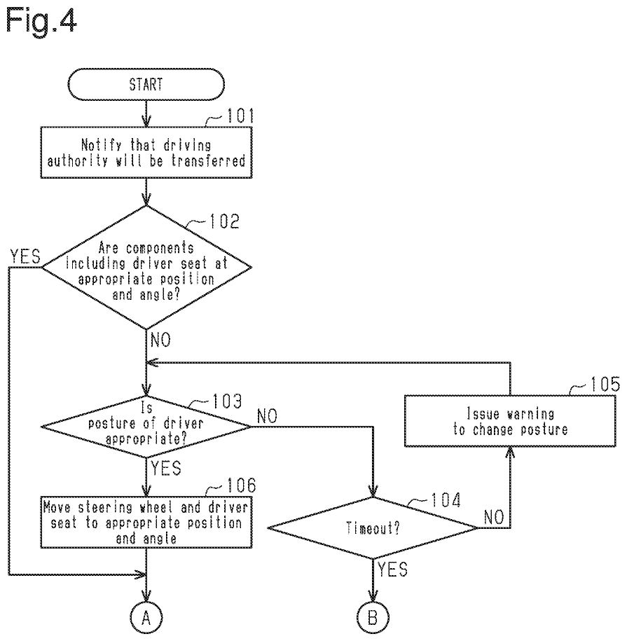

The flowcharts shown in FIGS. 4 to 6 show the driving authority transfer process, which is one of the various controls executed by the controller 35. The transfer process is executed whenever the autonomous driving mode becomes difficult to continue and the driver D1 is requested to perform driving operation in the manual driving mode.

Referring to FIG. 4, in step 101, the controller 35 notifies the driver D1 that the driving authority will be transferred. This notification is issued by, for example, outputting a pre-stored voice or sound effect from the speaker 33. The driver D1 hears the sound to recognize that the driving authority will be transferred. This allows the driver D1 to be prepared for performing driving operation in the manual driving mode.

The above notification may be output to the display 18 or may be output through wireless or wired communication from an electronic device, which is, for example, a smartphone, carried by the driver D1.

The process of step 101 executed by the controller 35 corresponds to a notifier that notifies the driver D1 that the driving authority will be transferred before the driving authority is transferred.

The above notification may be issued by moving the steering wheel 24 in the front-rear direction with the actuator 31 and/or changing the inclination angle of the steering wheel 24 with the actuator 32. Alternatively, the above notification may be issued by illuminating a light emitting member (not shown) incorporated in a member located at the front of the sightline of the driver D1 in the passenger compartment 11, which is, for example, the steering wheel 24, the instrument panel 17, or a pillar.

When the notification is issued by illuminating light emitting members, the light emitting members may be incorporated in an upper portion and a lower portion of the rim 25 of the steering wheel 24 so that the driver D1 readily notices the illumination of the light emitting members regardless of the direction in which the driver D is facing. The upper portion and the lower portion of the rim 25 refer to an upper portion and a lower portion of the steering wheel 24 positioned when the vehicle 10 travels straight forward (hereafter, referred to as “neutral position”). The light emitting members may be incorporated in other portions in addition to the upper portion and the lower portion of the rim 25. The notification may be issued by blowing cool air or warm air toward the driver D1 from an air conditioner (not shown).

When issuing the notification of the driving authority transfer, a notice containing information on the surroundings of the vehicle 10 may be issued at the same time. Such information includes, for example, the current location; the distance traveled before switching to the manual driving mode; the lane in which the vehicle should travel; and the degree of traffic congestion, the weather, and the state of the road surface at the point at which the authority transfer is planned to be completed.

Next, in step 102, it is determined whether the steering wheel 24 is in a position appropriate for diving operation in the manual driving mode, the front-rear position of the seat cushion 13 is appropriate for driving operation in the manual driving mode, and the inclination angle of the seat back 14 is appropriate for driving operation in the manual driving mode.

When the determination condition of step 102 is not satisfied, it is determined in step 103 whether the driver D1 has an appropriate posture. The appropriate posture refers to a posture having no or little interference with movement of the steering wheel 24 and the driver seat 12 performed in step 106, which will be described later. In an example of an inappropriate posture, the legs of the driver D1 are crossed and held between the steering wheel 24 and the driver seat 12. The above determination is made based on, for example, an image of the legs of the driver D1 captured by a camera (not shown) or a state of the legs of the driver D1 detected by a sensor (not shown) incorporated in the steering wheel 24.

When the determination condition of step 103 is not satisfied, it is determined in step 104 whether a predetermined time has elapsed from when the inappropriate posture of the driver D1 started to be detected. When the determination condition of step 104 is not satisfied, in step 105, a warning is issued to the driver D1 to change the inappropriate posture to an appropriate posture, for example, a posture without crossing his or her legs. The warning may be issued by outputting a voice from the speaker 33, showing an indication on the display 18, or outputting an indication or voice from an electronic device carried by the driver D1 in the same manner as step 101. When the driver D1 sees or hears the indication or voice, the driver D1 realizes that he or she is assuming an inappropriate posture and needs to assume an appropriate posture. After execution of step 105, step 103 is executed again. The determination of step 103 and the warning of step 105 are repeated until the driver D1 has assumed an appropriate posture.

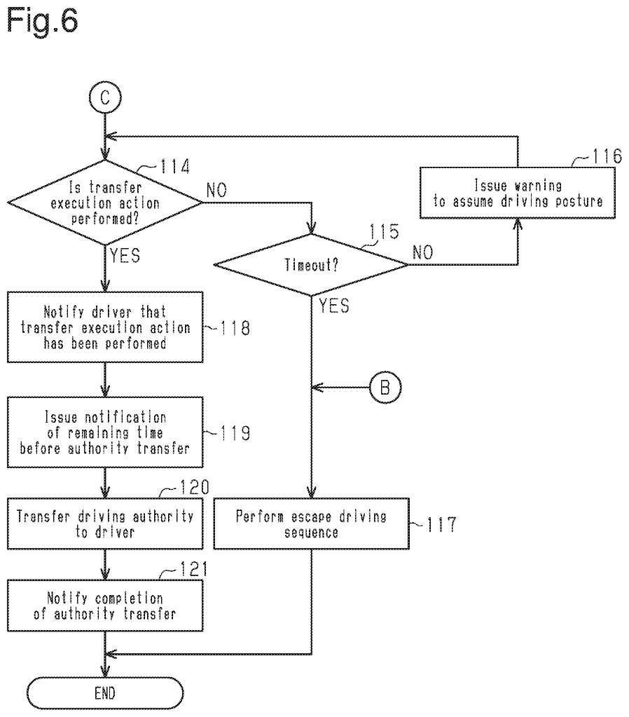

After it is detected in step 102 that the steering wheel 24 and the driver seat 12 do not have an appropriate position and an appropriate angle, when an inappropriate posture of the driver D1 is continuously detected for a predetermined time regardless of the warning of step 105, a timeout occurs in step 104. More specifically, it is determined that the transfer of the driving authority to the driver D1 is difficult, and step 117 in FIG. 6 is executed. In step 117, an escape driving sequence is executed to search for an escape area such as a shoulder or a wide space of the road so that the vehicle is slowly driven to and stopped at the escape area. In the escape driving sequence, the vehicle 10 may stop while intermittently illuminating an emergency flasher.

The escape driving sequence may be executed before the target highway exit. However, there is no limit to such a configuration. When the vehicle 10 has passed the target highway exit, the escape driving sequence may be executed before another exit.

After execution of step 117, the driving authority transfer process ends.

When the determination condition of step 103 is satisfied, in step 106, the actuators 31 and 32 are controlled so that the steering wheel 24 is moved to a position suitable for driving operation in the manual driving mode. In addition, the seat cushion driver 15 is controlled so that the seat cushion 13 is moved to a front-rear position suitable for driving operation in the manual driving mode. Also, the seat back driver 16 is controlled so that the seat back 14 is inclined, for example, from a reclined angle to an angle suitable for driving operation in the manual driving mode.

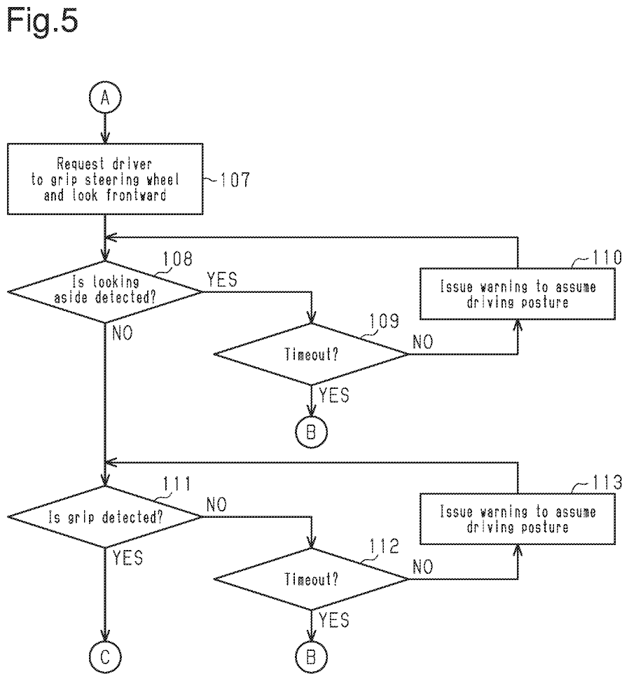

After execution of step 106 or when the determination condition of step 102 is satisfied, step 107 shown in FIG. 5 is executed. In step 107, the driver D1 is requested to grip the steering wheel 24 and look to the front. This request is issued by, for example, outputting a pre-stored voice or sound effect from the speaker 33. The driver D1 hears the sound to recognize that he or she has to grip the steering wheel 24 and face forward.

Next, in step 108, whether the driver D1 is looking to the front, that is, whether the driver D1 is not looking aside, is detected based on image data captured by the camera 34. For example, the controller 35 includes an image processor (not shown) for processing image data of a face to detect the direction of the face. When the direction of the face does not conform to a traveling direction of the vehicle 10 detected by a steering angle sensor (not shown), it is determined that the driver D1 is looking aside.

When the determination condition of step 108 is satisfied (when the driver D1 is looking aside), step 109 is executed to determine whether a predetermined time has elapsed from when the looking aside state started to be detected. When the determination condition of step 109 is not satisfied, in step 110, a warning is issued to the driver D1 to assume a driving posture (to face forward). The warning is issued by, for example, illuminating a light emitting member or outputting sound from the speaker 33. The warning may be issued by, for example, moving the seat cushion 13 in the front-rear direction. After execution of step 110, step 108 is executed again. The determination of step 108 and the warning of step 110 are repeated until the sightline of the driver D1 is directed to the front.

After the request to look to the front is made in step 107, when the looking aside state is continuously detected for a predetermine time regardless of the warning in step 110, it is determined in step 109 that a timeout has occurred, and step 117 is executed to execute the escape driving sequence. After execution of step 117, the driving authority transfer process ends.

Instead of the escape driving sequence, a process for requesting the driver D1 to grip the steering wheel 24 and look to the front may be executed again while the vehicle 10 continues to travel.

When the determination condition of step 108 is not satisfied, that is, when it is detected that the driver D1 is not looking aside and is facing forward, step 111 is executed. In step 111, the grip sensor 29 is used to determine whether the driver D1 is gripping the steering wheel 24. When the determination condition of step 111 is not satisfied (when the hands are removed from the steering wheel 24), step 112 is executed. In step 112, after removal of the hands from the steering wheel 24 starts to be detected, it is determined whether a predetermined time has elapsed.

When the determination condition of step 112 is not satisfied, that is, when the predetermined time has not elapsed, in step 113, a warning is issued to the driver D1 to assume a driving posture (to grip the steering wheel 24). The warning is issued by, for example, controlling the actuator 32 to change the inclination angle of the steering wheel 24. After execution of step 113, step 111 is executed again. The determination of step 111 and the warning of step 113 are repeated until the driver D1 grips the steering wheel 24.

After the request to grip the steering wheel 24 is made in step 107, and a state in which the steering wheel 24 is not gripped continuously is detected for a predetermined time regardless of the warning of step 113, it is determined in step 112 that a timeout has occurred, and step 117 is executed. As described above, after the escape driving sequence is executed in step 117, the driving authority transfer process is ended.

Steps 111 to 113 may be executed before steps 108 to 110.

When the determination condition of step 111 is satisfied, that is, when the driver D1 is facing forward and is gripping the steering wheel 24, it is determined in step 114 shown in FIG. 6 whether the preset transfer execution action is performed by the driver D1. Step 114 is executed to confirm the intention of the driver D1 to switch to the manual driving mode.

The transfer execution action includes, for example, one or a combination of the following actions (1) to (4).

(1) A continuous grip on the steering wheel 24 for a predetermined time.

In this case, the grip does not refer to a state in which the steering wheel 24 is just touched but refers to a state in which the steering wheel 24 is grasped with force.

The determination of whether this action is performed is made by, for example, measuring time for which the grip sensor 29 detects a grip.

(2) A grip on a portion of the rim 25 of the steering wheel 24 indicated with light or the like.

The determination of whether this action is performed is made based on, for example, a detection value of the grip sensor 29 incorporated in the indicated portion.

The portion indicated with light or the like may be left and right portions of the rim 25 when the steering wheel 24 is in the neutral position shown in FIG. 2.

The grip sensor 29 is provided in the entire circumference or a portion of the rim 25. However, it is desirable that a detection result on a position that may contact a body part of the driver D1 other than his or her hands DH is not used for the determination of the transfer execution action.

The body part of the driver D1 other than his or her hands DH that may contact the rim 25 is, for example, a knee DN. As shown in FIG. 3, when the steering wheel 24 is in the neutral position, the knee DN may contact a region Z1 of the rim 25, the region Z1 being defined as the area from the lower end of the rim 25 to 22.5° toward opposite sides in the circumferential direction (region of 45° as a whole). Therefore, it is desirable that a detection result of the grip sensor 29 in the region Z1 of the rim 25 is not used for the above determination, and a detection result in only a region Z2 excluding the region Z1 is used for the determination.

The portion indicated with light or the like may include both a front surface 25a and a rear surface 25b of the rim 25 in the front-back direction of the vehicle 10 as shown in FIG. 1.

(3) An action that is different from a grip on the steering wheel 24 and is taken when performing driving operation in the manual driving mode.

Such an action includes depressing the accelerator pedal 19 in an amount that is less than a predetermined amount. The determination of whether this action is performed is made based on, for example, an accelerator operation amount detected by the accelerator sensor 21.

If the accelerator pedal 19 is depressed, a quick deceleration of the vehicle 10 performed by an engine brake will be limited or reduced when switching from the autonomous driving mode to the manual driving mode. Also, if the depression amount of the accelerator pedal 19 is less than the predetermined amount, a quick acceleration of the vehicle 10 will be limited or reduced when switching from the autonomous driving mode to the manual driving mode.

Acceleration of the vehicle 10 may be used as an index value of the accelerator operation. An acceleration sensor may be used to detect the acceleration.

As an alternative to or in addition to the acceleration operation, the transfer execution action may include a pull on the steering wheel 24 and/or a look to the front. When a look to the front is the transfer execution action, the driving authority is transferred when the driver D1 is not looking aside (looking away). When the driver D1 is inattentive, the driver D1 may fail to pay attention to the traveling direction of the vehicle 10 or the head of the driver D1 may incline due to a lowered wakefulness. Hence, a look to the front may refer to, for example, a look to the front with the head not inclined by a predetermined value (e.g., 30°) or more from an angle appropriate for driving operation in the manual driving mode.

(4) When the authority transfer device includes an execution switch that transfers the driving authority, an activation of the execution switch, for example, pressing the execution switch down. Alternatively, when the authority transfer device includes a sound sensor so that the driving authority is transferred in response to sound, an instruction with voice (utterance) such as “please switch the driving mode from the autonomous driving mode to the manual driving mode.”

When activating the execution switch, the driver D1 may move the sightline from the front to the execution switch and remove one hand from the steering wheel 24 to operate the execution switch. This hinders the driver D1 from having a posture appropriate for driving operation in the manual driving mode. In the utterance operation, the driver D1 does not need to remove his or her hand from the steering wheel 24 and move his or her sightline away from the front. The driver D1 may perform driving operation in the manual driving mode while maintaining an appropriate driving posture.

When the determination condition of step 114 is not satisfied, that is, when the transfer execution action is not performed, step 115 is executed. In step 115, it is determined whether a predetermined time has elapsed from when it was first determined that the transfer execution action was not performed.

When the determination condition of step 115 is not satisfied, in step 116, a warning is issued to the driver D1 to assume a driving posture (to perform the transfer execution action). The warning is issued by, for example, moving the steering wheel 24 in the front-rear direction with the actuator 31 and/or changing the inclination angle of the steering wheel 24 to an angle different from that of step 113 with the actuator 32. After execution of step 116, step 114 is executed again. The determination of step 114 and the warning of step 116 are repeated until the driver D1 performs the transfer execution action.

A state in which the transfer execution action is not performed is detected for a predetermined time regardless of the warning of step 116, it is determined in step 115 that a timeout has occurred, and step 117 is executed. As described above, after the escape driving sequence is executed in step 117, the driving authority transfer process is ended.

When the determination condition of step 114 is satisfied, that is, when the transfer execution action is performed by the driver D1, step 118 is executed to notify the driver D1, before the driving authority is transferred, that the transfer execution action has been performed and that the driving mode is ready to be switched to the manual driving mode.

As described above, a grip on the steering wheel 24 (the determination condition of step 111 being satisfied) is a precondition for performing the transfer execution action. Thus, the above notification indirectly notifies the driver D1 that a grip on the steering wheel 24 is detected. This allows the driver D1 to recognize that a grip on the steering wheel 24 is detected in addition to that performance of the transfer execution action is recognized.

The process of step 118 executed by the controller 35 corresponds to a notifier that notifies the driver D1 that a grip on the steering wheel 24 is detected before the driving authority is transferred.

The above notification may be issued by, for example, vibrating the steering wheel 24 with the vibration generators 28. Alternatively, the above notification may be issued by illuminating a light emitting member incorporated in a member located at the front of the sightline of the driver D1 in the passenger compartment 11, which is, for example, the steering wheel 24, the instrument panel 17, or a pillar. The above notification may be issued by blowing cool air or warm air toward the driver D1 from an air conditioner (not shown). The notification may be issued by outputting a pre-stored voice or sound effect from the speaker 33. The notification may be issued using one or a combination of vibration, light, air, and sound described above.

Then, step 119 is executed to calculate a remaining time before the driving authority is transferred and notifies the remaining time to the driver D1. In an example, the remaining time is indicated in numerals on the display 18. In another example, light emitting members may be incorporated in the rim 25 of the steering wheel 24 at multiple positions separated in the circumferential direction, and the number of light emitting members that are illuminated may be reduced as time elapses to indicate the remaining time. The above notification may be issued by, for example, vibrating the steering wheel 24 with the vibration generators 28 and changing a mode of the vibration as time elapses. For example, the vibration generators 28 may vibrate twice ten seconds before the driving authority is transferred and may vibrate three times three seconds before the driving authority is transferred. The notification may be issued by outputting a pre-stored voice or sound effect from the speaker 33.

The process of step 119 executed by the controller 35 corresponds to a notifier that notifies the driver D1 of the remaining time before the driving authority is transferred.

Next, in step 120, the driving authority of the vehicle 10 is transferred to the driver D1. Step 120 is executed to switch the subject of the driving authority to the driver D1.

In step 121, completion of the transfer of the driving authority is notified with, for example, sound, light, or vibration. With this notification, the driver D1 recognizes that the driving authority transfer has been completed and that the driving mode has been switched from the autonomous driving mode to the manual driving mode.

Operation and advantages of the present embodiment configured as described above will now be described.

In the driving authority transfer process shown in FIGS. 4 to 6, when switching the driving mode from the autonomous driving mode to the manual driving mode, the authority to drive the vehicle 10 is transferred to the driver D1 on condition that at least a grip on the steering wheel 24 by the driver D1 is detected.

Before the driving authority is transferred, the driver D1 is notified of the transfer of the driving authority (step 101). With the notification, the driver D1 recognizes that the driving authority will be transferred.

In addition, before the driving authority is transferred, the driver D1 is notified that a grip on the steering wheel 24 is detected and that the driving mode is ready to be switched to the manual driving mode (step 118). With the notification, the driver D1 recognizes that a grip on the steering wheel 24 is detected and that the driving authority will be transferred. When this notification is issued using a combination of two or more of vibration, light, air, and sound described above, the driver D1 is effectively notified that a grip on the steering wheel 24 is detected before the driving authority is transferred. The notification issued using multiple means is received more adequately than notification issued using a single means.

The driver D1 is notified of the remaining time before the driving authority is transferred (step 119). The driver D1 recognizes that the driving authority will be transferred when the notified remaining time elapses, that is, recognizes when the driving authority is transferred.

Thus, the driver D1 receives more information than when the authority transfer execution condition is only detection of a grip on the steering wheel 24. Thus, when the driver D1 is sufficiently prepared for an appropriate response to driving operation in the manual driving mode, the driver D1 receives the transfer of the driving authority.

Further, in the present embodiment, the authority to drive the vehicle 10 is transferred to the driver D1 on condition that a preset transfer execution action is performed by the driver D1 in addition to that a grip on the steering wheel 24 by the driver D1 is detected. The preset transfer execution action includes a continuous grip on the steering wheel 24 by the driver D1 for a predetermined time, a grip on a portion of the steering wheel 24 indicated with light or the like, and/or another action that is different from a grip on the steering wheel 24 and is performed when driving operation in the manual driving mode.

When the driver D1 performs any one of the transfer execution actions described above, preparation for an appropriate response to driving operation in the manual driving mode is enhanced as compared to when the driver D1 merely grips the steering wheel 24. When the condition for transferring the authority includes the transfer execution action in addition to a grip on the steering wheel by the driver, the authority transfer further reflects the intention of the driver.

The embodiment may be modified as follows.

The authority transfer device described above may be used as an authority transfer device that does not have functionality to control the actuators 31 and 32 to move the steering wheel 24 and the driver seat 12 to appropriate positions. In this case, when the determination condition of step 103 is satisfied in the driving authority transfer process, the following process of step 106 may be manually executed instead of using the actuators 31 and 32. When the steering wheel 24 and the driver seat 12 are manually moved to appropriate positions, the driving consciousness of the driver D1 is increased.

Before step 101, a step may be executed to notify the driver D1 of, for example, an estimated duration until steps 101 to 108, an estimated duration until steps 101 to 111, and/or an estimated duration until steps 101 to 114 in advance. The time elapsing before the driving authority is transferred may be estimated based on vehicle speed and a calculated distance between the current location of the vehicle 10 and the point at which the driving authority is transferred (e.g., point at which the vehicle gets off highway to local road). The advance notification may be issued by, for example, indicating the estimated durations in numerals on the display 18. The advance notification of the estimated duration allows the driver D1 to be mentally prepared for the transfer of the driving authority before step 101. As a result, the driver D1 will not be surprised by a sudden notification of the transfer of the driving authority.

When the driver D1 is using a paper medium such as a book or newspaper that cannot be electrically connected to the controller 35, to ensure that the driver D1 receives information on the transfer of the driving authority, various types of information described above may be notified by projecting a message from a map lamp onto the surface of the paper the driver D1 is looking at. In this case, it is desirable that the map lamp has functionality to focus the projected message. Further, an image of the driver D1 may be captured by the camera 34 so that the sightline of the driver D1 is calculated and the message is projected on the surface of the paper at the front of the calculated sightline.

When newspaper is used, the message may be projected from the rear of the newspaper using strong light. In this case, the driver D1 sees the message emerged from the newspaper.

With the configuration described above, even when the driver D1 is using a paper medium that cannot be electrically connected to the controller 35, a message related to the transfer of the driving authority is indicated within the sightline of the driver D1, so that the message is received by the driver D1. The driver D1 readily recognizes the message.

Instead of showing the message on a surface of paper, the paper medium used by the driver D1 may be vibrated by ultrasound so that the information is at least partially notified.

Instead of showing a message, a light emitting member may be illuminated continuously or intermittently.

When the driver D1 is looking outside the vehicle through window glass, a message may be projected on the window glass.

In step 107 shown in FIG. 5, when issuing a request to grip the steering wheel 24, a position of the steering wheel 24 that is requested to be gripped by the driver D1 may be illuminated. In addition, the display 18 may show notification of “please grip illuminated part.” Thus, when the driver D1 sees the illuminated part of the steering wheel 24 or sees or hears the notification, the driver D1 recognizes that the illuminated part of the steering wheel 24 is to be gripped.

In step 111 shown in FIG. 5, when a grip on the steering wheel 24 by the driver D1 is detected, the detection of a grip on the steering wheel 24 may be directly notified to the driver D1 before the driving authority is transferred. This notification may be issued as a part of step 118 shown in FIG. 6 or may be executed as a step different from step 118. The notification may be issued by showing an indication on the display 18 or using the same process as step 118 described above.

In the flowcharts shown in FIGS. 4 to 6, one or two of the step of transferring the driving authority to the driver D1 (step 101), the step of notifying the driver D1 that a grip on the steering wheel 24 is detected (step 118), and the step of notifying the driver D1 of the remaining time before the driving authority is transferred (step 119) may be omitted.

In steps 105, 110, 113, and 116 of the flowcharts shown in FIGS. 4 to 6, the warning may be issued in a manner differing from the embodiment. For example, in steps 113 and 116, the warning may be issued by outputting a pre-stored voice or sound effect from the speaker 33. When the warning is repeated in step 105, 110, 113, or 116, the amount of output sound and/or the intensity of emitted light may be increased in a stepped manner.

The above embodiment relates to automatic switching to the manual driving mode when the autonomous driving mode becomes difficult to continue. Alternatively, the notification in the same manner as in the above embodiment is also possible in the case where the autonomous driving mode is immediately switched to the manual driving mode when the driver D1 operates the steering wheel 24, the accelerator pedal 19, or the brake pedal during the autonomous driving mode. More specifically, before the driving authority is transferred, at least one of (1) transfer of the driving authority, (2) detection of a grip on the steering wheel 24, and (3) remaining time before the driving authority is transferred may be notified to the driver D1.

The authority transfer device may be provided as a computer program configured to cause the controller 35 to execute the driving authority transfer process or a computer readable medium including a computer executable command or code configured to cause the controller 35 to execute the driving authority transfer process. Such a computer readable media may be a RAM, a flash memory, a ROM, an EPROM, an EEPROM, a resistor, a hard disk, a removable disk, or a CD-ROM but is not limited thereto. The computer readable media may be a non-transitory computer readable medium. The controller 35 may include a processor executing the computer executable command. The computer readable medium may be connected to or integrated with the processor so that the processor reads and executes the command or the code from the computer readable medium.

In an example, the computer program is a driving authority transfer program executed by a processor used for a vehicle having an autonomous driving mode in which driving operation is autonomously performed for a driver and a manual driving mode in which driving operation is manually performed by the driver using at least a steering wheel. The computer program causes the processor to execute:

a step of actuating a display, a wireless or wired communication device, a vibration generator, a steering wheel actuator, a speaker, a light emitting member, an air conditioner, or any combination of these to notify the driver that the driving authority will be transferred;

a step of obtaining grip information of the steering wheel by the driver detected by a grip sensor; and

a step of transferring the driving authority of the vehicle to the driver when a grip on the steering wheel by the driver is detected.

In another example, the computer program is a driving authority transfer program executed by a processor used for a vehicle having an autonomous driving mode in which driving operation is autonomously performed for a driver and a manual driving mode in which driving operation is manually performed by the driver using at least a steering wheel. The computer program causes the processor to execute:

a step of obtaining grip information of the steering wheel by the driver detected by a grip sensor;

when a grip on the steering wheel by the driver is detected, a step of actuating a display, a vibration generator, a steering wheel actuator, a speaker, a light emitting member, an air conditioner, or any combination of these to notify the driver that a grip on the steering wheel is detected; and

a step of transferring the driving authority of the vehicle to the driver.

In yet another example, the computer program is a driving authority transfer program executed by a processor used for a vehicle having an autonomous driving mode in which driving operation is autonomously performed for a driver and a manual driving mode in which driving operation is manually performed by the driver using at least a steering wheel. The computer program causes the processor to execute:

a step of obtaining grip information of the steering wheel by the driver detected by a grip sensor;

when a grip on the steering wheel by the driver is detected, a step of actuating a display, a vibration generator, a speaker, a light emitting member, or any combination of these to notify the driver of the remaining time before the driving authority is transferred; and

a step of transferring the driving authority of the vehicle to the driver.

The driving authority transfer program may be further configured to cause the processor to execute:

a step of obtaining information on a transfer execution action selected from (i) a continuous grip on the steering wheel for a predetermined time, (ii) a grip on an indicated portion of the steering wheel, (iii) another action that is different from a grip on the steering wheel and is performed when perform driving operation in the manual driving mode, and/or (iv) an activation of an execution switch provided on the authority transfer device to transfer the driving authority or an instruction with utterance to switch from the autonomous driving mode to the manual driving mode, wherein the information on the transfer execution action is detected by the grip sensor, the accelerator sensor, the acceleration sensor, the image processor, the execution switch, and/or the sound sensor; and

a step of transferring the driving authority of the vehicle to the driver when the transfer execution action is detected in addition to detection of a grip on the steering wheel by the driver.

The present disclosure is not intended to be limited to the exemplified embodiments. For example, the exemplified features should not be understood as being essential to the present disclosure. The subject matter of the present disclosure may exist in fewer features than all of the features of the particular embodiments disclosed. The present disclosure is shown by the claims and is intended to include all modifications within the scope equivalent to the claims.

1. An authority transfer device used for a vehicle having an autonomous driving mode in which driving operation is autonomously performed for a driver and a manual driving mode in which driving operation is manually performed by the driver using at least a steering wheel, the authority transfer device comprising a processor configured, when switching from the autonomous driving mode to the manual driving mode, to transfer a driving authority of the vehicle to the driver on condition that at least a grip of the driver on the steering wheel is detected, and one or more selected from the group consisting of:
a notifier to notify the driver that the driving authority will be transferred before the driving authority is transferred;
a notifier to notify the driver that a grip on the steering wheel is detected before the driving authority is transferred; and
a notifier to notify the driver of a remaining time before the driving authority is transferred.

2. (canceled)

3. (canceled)

4. The authority transfer device according to claim 1, wherein
the processor is configured to transfer the driving authority of the vehicle to the driver on condition that a preset transfer execution action is performed by the driver in addition to detection of a grip on the steering wheel by the driver, and
the preset transfer execution action includes one or more selected from the group consisting of:
a continuous grip on the steering wheel for a predetermined time;
a grip on an indicated portion of the steering wheel; and
an action that is different from a grip on the steering wheel and is taken when performing driving operating in the manual driving mode.

5. (canceled)

6. (canceled)

7. The authority transfer device according to claim 1 comprising the notifier to notify the driver that the driving authority will be transferred before the driving authority is transferred.

8. The authority transfer device according to claim 1 comprising the notifier to notify the driver that a grip on the steering wheel is detected before the driving authority is transferred.

9. The authority transfer device according to claim 1 comprising the notifier to notify the driver of a remaining time before the driving authority is transferred.

10. The authority transfer device according to claim 4, wherein the preset transfer execution action includes the continuous grip on the steering wheel for a predetermined time.

11. The authority transfer device according to claim 4, wherein the preset transfer execution action includes the grip on an indicated portion of the steering wheel.

12. The authority transfer device according to claim 4, wherein the preset transfer execution action includes the action that is different from a grip on the steering wheel and is taken when performing driving operation in the manual driving mode.
